(19) United States
(12) Patent Application Publication
(10) Pub. No.: US 2021/0277253 A1
(43) Pub. Date: Sep. 9, 2021

(54) PHOTOCATALYTIC COATING MATERIAL AND SPRAYER PRODUCT

(71) Applicant: SHARP KABUSHIKI KAISHA, Sakai City (JP)

(72) Inventors: TAKESHI SATOH, Sakai City (JP); YOSHITAKA KAWASE, Sakai City (JP); TOMOYA TSUTSUMINO, Sakai City (JP)

(21) Appl. No.: 17/186,906

(22) Filed: Feb. 26, 2021

(30) Foreign Application Priority Data
Mar. 3, 2020 (JP) 2020-035903

(51) Int. Cl. C09D 5/02; C09D 7/61; C09D 7/40; B05D 1/02; B05D 3/06

(52) U.S. Cl. CPC C09D 5/025; C09D 5/027; B05D 3/067; C09D 7/68; B05D 1/02; C09D 7/61

(57) ABSTRACT

The present invention provides a photocatalytic coating material that can be stored for an extended period of time without allowing proliferation of, for example, bacteria and fungi. The photocatalytic coating material in accordance with the present invention contains: a dispersion medium containing water; photocatalytic fine particles dispersed in the dispersion medium; and silver ions, a concentration of the silver ions of the photocatalytic coating material is 0.6 ppm or more.

### CROSS-REFERENCE TO RELATED APPLICATIONS

The present application claims the benefit of priority to Japanese Patent Application, Tokugan, No. 2020-035903 filed on Mar. 3, 2020, the entire contents of which are incorporated herein by reference.

### FIELD OF THE INVENTION

The present invention relates to photocatalytic coating materials and sprayer products.

### BACKGROUND OF THE INVENTION

Common photocatalytic coating materials typically contain an antiseptic to reduce fungus development and related decomposition in the liquid medium in long term storage because bacteria and fungi in the air could otherwise contaminate the liquid medium during manufacture or use and proliferate in the liquid medium. Some commercially available photocatalytic coating materials contain ethanol as an antiseptic component.

Some people however are allergic to ethanol and get skin problems from ethanol. There is consumer demand for ethanol-free or low-ethanol-concentration products.

Meanwhile, photocatalytic paints are known that contain photocatalytic particles carrying antibacterial metal particles (see, for example, Japanese Unexamined Patent Application Publication, Tokukai, No. 2019-099736).

### SUMMARY OF THE INVENTION

### Problems to be Solved by the Invention

Ethanol does not exhibit a sufficient antiseptic effect in ethanol-free and low-ethanol-concentration products. Therefore, an antiseptic such as methylparaben or sodium benzoate needs to be added to the photocatalytic coating material. Many of these antiseptics however inhibit the antiseptic effect of the photocatalyst when added to the product, presumably for the following reasons. The photocatalytic coating material dries when sprayed, so that the photocatalytic fine particles can start to take effect. But, the photocatalyst first decomposes the nearby antiseptic and hence becomes less effective in decomposing toxic gases in the air. The antiseptics are not able to retain the antiseptic effects thereof in long term storage in bright places, presumably because the photocatalyst decomposes the antiseptics in the liquid medium.

Paints containing antibacterial fine metal particles do not exhibit a sufficient antiseptic effect because not many metal ions elute from the fine particles to the liquid medium.

The present invention has been made in view of these issues to provide a photocatalytic coating material that can be stored for an extended period of time without allowing proliferation of, for example, bacteria and fungi.

### Solution to the Problems

The present invention provides a photocatalytic coating material including: a dispersion medium containing water; photocatalytic fine particles dispersed in the dispersion medium; and silver ions, wherein a concentration of the silver ions of the photocatalytic coating material is 0.6 ppm or more.

### Advantageous Effects of the Invention

Since a concentration of the silver ions of the photocatalytic coating material is 0.6 ppm or more in accordance with the present invention, the silver ions can serve as an antiseptic. The photocatalytic coating material can be hence stored for an extended period of time without allowing proliferation of, for example, bacteria and fungi.

The silver ions do not inhibit the photocatalytic activity of the photocatalytic fine particles. A photocatalytic layer of the photocatalytic coating material can exhibit, for example, a photocatalytic deodorizing effect thereof from the very beginning.

### BRIEF DESCRIPTION OF DRAWINGS

FIG. 1 is a schematic cross-sectional view of a sprayer product in accordance with an embodiment of the present invention.

### DESCRIPTION OF EMBODIMENTS

A photocatalytic coating material in accordance with the present invention contains: a dispersion medium containing water; photocatalytic fine particles dispersed in the dispersion medium; and silver ions, wherein a concentration of the silver ions of the photocatalytic coating material is 0.6 ppm or more.

The photocatalytic coating material in accordance with the present invention preferably further contains zinc ions. In this particular composition, the silver ions and the zinc ions can serve as an antiseptic. The photocatalytic coating material can be hence stored for an extended period of time without allowing proliferation of, for example, bacteria and fungi.

The photocatalytic fine particles in the photocatalytic coating material preferably have a volume average particle diameter D50 of 500 nm or less as measured by laser diffraction/scattering. This particular specification allows the photocatalytic fine particles to remain well dispersed in the photocatalytic coating material for an extended period of time.

The photocatalytic fine particles in the photocatalytic coating material in accordance with the present invention preferably contain tungsten oxide as a primary component. A photocatalytic layer can be formed of this photocatalytic coating material containing tungsten oxide. The photocatalytic layer can exhibit, for example, a deodorizing effect under visible light.

The photocatalytic coating material in accordance with the present invention preferably further contains an inorganic porous material. Additionally, the silver ions in the photocatalytic coating material are preferably either carried by the inorganic porous material or eluted from the inorganic porous material into the dispersion medium. In this particular composition, the silver ions can serve as an antiseptic. The photocatalytic coating material can be hence stored for an extended period of time without allowing proliferation of, for example, bacteria and fungi.

The photocatalytic coating material in accordance with the present invention preferably further contains a dispersant. In this particular composition, the photocatalytic fine particles in the photocatalytic coating material can be better dispersed.

The present invention further provides a sprayer product including: one of the photocatalytic coating materials in accordance with the present invention; and a sprayer that sprays the photocatalytic coating material.

The following will describe the present invention in more detail by way of embodiments. The arrangements detailed in the drawings and the following description are mere examples, and the scope of the present invention is by no means limited to the embodiments and examples given in the drawings and the description.

### First Embodiment

A photocatalytic coating material in accordance with the present embodiment includes: a dispersion medium containing water; photocatalytic fine particles dispersed in the dispersion medium; and silver ions, wherein a concentration of the silver ions of the photocatalytic coating material is 0.6 ppm or more.

The photocatalytic coating material (photocatalytic coating solution) is a suspension of photocatalytic fine particles dispersed in a dispersion medium containing water. The photocatalytic coating material is a coating substance for forming a photocatalytic layer on the surface of a base member. The photocatalytic coating material may be contained in a storage container, a spray bottle, or a sprayer product.

The photocatalytic coating material may be applied to the surface of a base member by any method including spray coating, dip coating, screen printing, spin coating, brush painting, roller painting, or roll coating.

The photocatalytic coating material is applied to the surface of a base member to form a coating film. Then, the dispersion medium in the coating film evaporates, leaving a photocatalytic layer formed on the surface of the base member.

The photocatalytic coating material may either be an ethanol-free aqueous suspension or contain 3% or less ethanol.

The dispersion medium in the photocatalytic coating material is composed primarily of water and may contain 99% or more water. The dispersion medium may alternatively be a water-ethanol mixture containing 3% or less ethanol.

The photocatalytic coating material may contain a dispersant. The dispersant is, for example, a surfactant. This particular composition enables the photocatalytic fine particles to be stably dispersed in the photocatalytic coating material for an extended period of time. The dispersant in the photocatalytic coating material is, for example, a nonionic surfactant or a cationic surfactant (polymer amine compound), preferably a cationic surfactant.

The photocatalytic coating material may contain a binder. The binder is, for example, a silane coupling agent.

The photocatalytic fine particles in the photocatalytic coating material are, for example, fine particles of a visible-light-responsive photocatalyst, more specifically, fine particles of tungsten oxide. The tungsten oxide is, for example, WO₃ (tungsten trioxide). The WO₃ may be oxygen deficient. Some tungstens in the WO₃ may be replaced by another metallic element. The photocatalytic fine particles have an average primary particle diameter of, for example, from 5 nm to 200 nm, both inclusive.

The photocatalytic fine particles may have a co-catalyst on the surface thereof. The co-catalyst is, for example, a platinum group metal such as platinum, palladium, rhodium, ruthenium, osmium, or iridium, gold, silver, copper, or zinc. The co-catalyst is preferably platinum. The co-catalyst may be adhered to the surface of the photocatalytic fine particles either in the form of fine metal particles or in the form of an oxide or a hydroxide.

The photocatalytic fine particles in the photocatalytic coating material may have a volume average particle diameter D50 (average particle diameter of the photocatalytic fine particles dispersed in the dispersion medium) of 500 nm or less as measured by laser diffraction/scattering (microtracking). This particular specification allows the photocatalytic fine particles to remain well dispersed in the photocatalytic coating material for an extended period of time.

Laser diffraction/scattering is capable of measuring, for example, the distribution of the secondary particle diameter (or the primary particle diameter) of the photocatalytic fine particles dispersed in the photocatalytic coating material, as well as measuring the average particle diameter D50. The volume average particle diameter D50 may be from 5 nm to 500 nm, both inclusive and may be from 5 nm to 250 nm, both inclusive.

The photocatalytic coating material contains 0.6 ppm (ppmw) or more silver ions. The photocatalytic coating material preferably contains 0.6 ppm to 10 ppm silver ions. Silver ions are antibacterial and hence capable of suppressing proliferation of, for example, bacteria and fungi in the photocatalytic coating material in long term storage of the photocatalytic coating material. The silver ions can hence serve as an antiseptic. In addition, silver ions do not inhibit the photocatalytic activity of the photocatalytic fine particles. The photocatalytic layer of the photocatalytic coating material can therefore exhibit, for example, a photocatalytic deodorizing effect thereof from the very beginning. The silver ions are contained as such, not in the form of metallic silver or silver oxide, in the photocatalytic coating material.

As an example, a silver compound such as silver nitrate may be dissolved in the photocatalytic coating material. The photocatalytic coating material may contain an inorganic porous material carrying silver ions.

The photocatalytic coating material may contain both silver ions and zinc ions. When this is actually the case, the photocatalytic coating material contains, for example, 0.6 ppm to 10 ppm silver ions and 3 ppm to 50 ppm, preferably 3 ppm to 10 ppm, zinc ions. For instance, both a silver compound such as silver nitrate and a zinc compound such as zinc chloride may be dissolved in the photocatalytic coating material. The photocatalytic coating material may contain an inorganic porous material carrying both silver ions and zinc ions. The photocatalytic coating material may alternatively contain both an inorganic porous material carrying silver ions and an inorganic porous material carrying zinc ions.

The inorganic porous material is, for example, porous ceramics, porous glass, or porous metal. The inorganic porous material is particulate and may have any particle diameter. The inorganic porous material preferably may have an average particle diameter (D50) of from 0.5 μm to 30 μm, both inclusive. The inorganic porous material preferably accounts, for example, for from 0.001 wt % to 0.025 wt % of the photocatalytic coating material.

More specifically, the inorganic porous material is, for example, zeolite carrying silver ions, zeolite carrying both silver ions and zinc ions, or zeolite carrying zinc ions. In the photocatalytic coating material containing such an inorganic porous material, the silver ions or the zinc ions are eluted from the inorganic porous material into the dispersion medium. The silver atoms are present in the form of ions (monovalent cations) in the inorganic porous material. The zinc atoms are present in the form of ions (divalent cations) in the inorganic porous material. The silver and zinc ions in the photocatalytic coating material can be analyzed and/or detected by, for example, ICP emission spectroscopy or fluorescence X-ray spectroscopy.

The zinc ions may have any concentration in the photocatalytic coating material. The photocatalytic coating material contains preferably 50 ppm or less zinc ions and more preferably 10 ppm or less zinc ions.

The photocatalytic coating material may be manufactured by, for example, the following process.

First, the photocatalytic fine particles (as well as a dispersant when necessary) are added to, and dispersed in, water (dispersion medium). The photocatalytic fine particles are dispersed in water typically using a wet disperser. The disperser may be, for example, an ultrasonic disperser, a colloid mill, or a bead mill.

Next, silver ions (or both silver ions and zinc ions) as an antiseptic are added to the suspension of dispersed photocatalytic fine particles. More specifically, for example, an inorganic porous material carrying silver ions, an inorganic porous material carrying both silver ions and zinc ions, or a silver compound is added to the suspension. These ingredients may be mixed using a general liquid mixer. Use of a mixer that is complete with, for example, stirrer blades leads to a more uniform composition of the photocatalytic coating material.

### Second Embodiment

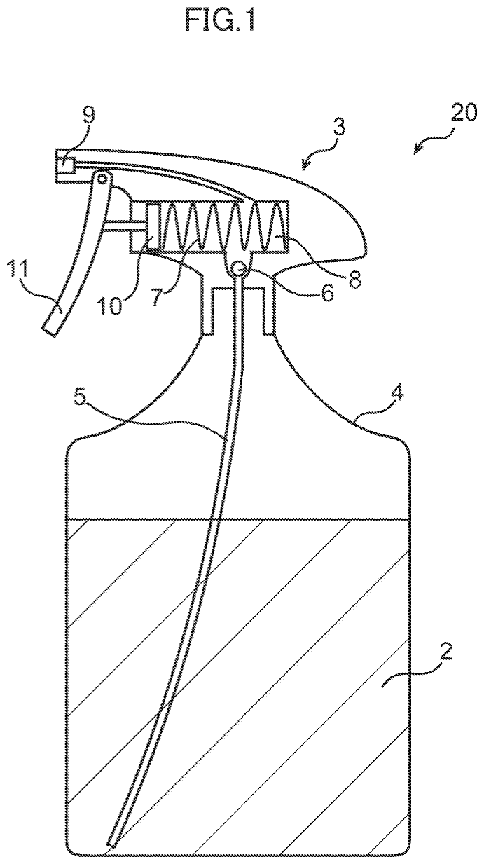

A second embodiment relates to sprayer products. FIG. 1 is a schematic cross-sectional view of a sprayer product in accordance with the present embodiment. A sprayer product 20 includes: a photocatalytic coating material 2 in accordance with the first embodiment; and a sprayer 3 that sprays the photocatalytic coating material 2.

The sprayer 3 may have a trigger sprayer structure in which when a trigger 11 is pressed, the photocatalytic coating material 2 inside a chamber 8 is sprayed through a spray nozzle 9 under the pressure applied thereto by a plunger 10 connected to the trigger 11.

### Photocatalytic Coating Material Preparation Experiments

Photocatalytic coating materials were prepared in Examples 1 to 7 and Comparative Examples 1 to 6.

### Example 1

A slurry (2.3 grams) containing 21 wt % photocatalytic fine particles dispersed therein was mixed with 97.6 grams of water and 4 milligrams of a compound product (0.06 milligrams of silver ions), to prepare a photocatalytic coating material (100 mL). The photocatalytic fine particles had a volume average particle diameter D50 of 200 nm. The compound product was zeolite fine particles carrying 1.5 wt % silver ions. The photocatalytic fine particles were Pt-carrying WO₃ powder.

### Example 2

A photocatalytic coating material was prepared by the same procedures as in Example 1, except that the photocatalytic fine particles had a volume average particle diameter D50 of 450 nm, silver ions (0.06 milligrams) and zinc ions (0.3 milligrams) were added, and the compound product was changed to zeolite fine particles carrying silver ions and zinc ions. The amount of the compound product added was adjusted in accordance with the amount of ions added, which applies to the other examples and comparative examples.

### Example 3

A photocatalytic coating material was prepared by the same procedures as in Example 1, except that the amount of silver ions added was changed to 0.25 milligrams.

### Example 4

A photocatalytic coating material was prepared by the same procedures as in Example 1, except that the amount of silver ions added was changed to 0.21 milligrams, the amount of zinc ions added was changed to 0.48 milligrams, and the compound product was changed to zeolite fine particles carrying silver ions and zinc ions.

### Example 5

A photocatalytic coating material was prepared by the same procedures as in Example 1, except that the photocatalytic fine particles had a volume average particle diameter D50 of 600 nm.

### Example 6

A photocatalytic coating material was prepared by the same procedures as in Example 1, except that 0.2 grams of Amiet 320 (manufactured by Kao Corporation) was added as a dispersant to the photocatalytic coating material.

### Example 7

A photocatalytic coating material was prepared by the same procedures as in Example 1, except that 0.2 grams of Esleam AD-3172M (manufactured by NOF Corporation) was added as a dispersant to the photocatalytic coating material.

Table 1 collectively shows, for example, the components of the photocatalytic coating materials of Examples 1 to 7.

TABLE 1

| | Photocatalytic Fine | | Antiseptic | | Dispersant | |
|---|---|---|---|---|---|---|
| | Particles | | Silver | Zinc | Amiet | |
| | Concentration | D50 | Ions | Ions | 320 | Esleam |
| Example 1 | 0.50 wt % | 200 nm | 0.6 ppm | 0 ppm | 0 wt % | 0 wt % |
| Example 2 | 0.50 wt % | 450 nm | 0.6 ppm | 3 ppm | 0 wt % | 0 wt % |
| Example 3 | 0.50 wt % | 200 nm | 2.5 ppm | 0 ppm | 0 wt % | 0 wt % |
| Example 4 | 0.50 wt % | 200 nm | 2.1 ppm | 4.8 ppm | 0 wt % | 0 wt % |
| Example 5 | 0.50 wt % | 600 nm | 0.6 ppm | 0 ppm | 0 wt % | 0 wt % |
| Example 6 | 0.50 wt % | 200 nm | 0.6 ppm | 0 ppm | 0.20 wt % | 0 wt % |
| Example 7 | 0.50 wt % | 200 nm | 0.6 ppm | 0 ppm | 0 wt % | 0.20 wt % |

### Comparative Example 1

A photocatalytic coating material was prepared by the same procedures as in Example 1, except that the amount of silver ions added was changed to 0.03 milligrams.

### Comparative Example 2

A photocatalytic coating material was prepared by the same procedures as in Example 1 or Example 2, except that the amount of silver ions added was changed to 0.03 milligrams and the amount of zinc ions added was changed to 0.15 milligrams.

### Comparative Example 3

A photocatalytic coating material was prepared by the same procedures as in Example 1, except that methylparaben (0.02 grams) instead of silver ions was added as an antiseptic.

### Comparative Example 4

A photocatalytic coating material was prepared by the same procedures as in Example 1, except that methylparaben (0.05 grams) instead of silver ions was added as an antiseptic.

### Comparative Example 5

A photocatalytic coating material was prepared by the same procedures as in Example 1, except that sodium benzoate (0.02 grams) instead of silver ions was added as an antiseptic.

### Comparative Example 6

A photocatalytic coating material was prepared by the same procedures as in Example 1, except that sodium benzoate (0.05 grams) instead of silver ions was added as an antiseptic.

Table 2 collectively shows, for example, the components of the photocatalytic coating materials of Comparative Examples 1 to 6.

TABLE 2

| | Photocatalytic Fine | | Antiseptic | | | | Dispersant | |
|---|---|---|---|---|---|---|---|---|
| | Particles | | Silver | Zinc | | Sodium | Amiet | |
| | Concentration | D50 | Ions | Ions | Methylparaben | Benzoate | 320 | Esleam |
| Comp. Ex. 1 | 0.50 wt % | 200 nm | 0.3 ppm | 0 ppm | 0 wt % | 0 wt % | 0 wt % | 0 wt % |
| Comp. Ex. 2 | 0.50 wt % | 200 nm | 0.3 ppm | 1.5 ppm | 0 wt % | 0 wt % | 0 wt % | 0 wt % |
| Comp. Ex. 3 | 0.50 wt % | 200 nm | 0 ppm | 0 ppm | 0.02 wt % | 0 wt % | 0 wt % | 0 wt % |
| Comp. Ex. 4 | 0.50 wt % | 200 nm | 0 ppm | 0 ppm | 0.05 wt % | 0 wt % | 0 wt % | 0 wt % |
| Comp. Ex. 5 | 0.50 wt % | 200 nm | 0 ppm | 0 ppm | 0 wt % | 0.02 wt % | 0 wt % | 0 wt % |
| Comp. Ex. 6 | 0.50 wt % | 200 nm | 0 ppm | 0 ppm | 0 wt % | 0.05 wt % | 0 wt % | 0 wt % |

Comp. Ex. = Comparative Example

### Evaluation of Prepared Photocatalytic Coating Material

### Evaluation of Dispersion

After being prepared, the photocatalytic coating material was thoroughly stirred and let to sit. The photocatalytic coating material was evaluated as being poor if the photocatalytic fine particles aggregated and precipitated in 1 day, fair if the photocatalytic fine particles aggregated and precipitated in 3 days, good if the photocatalytic fine particles aggregated and precipitated in 7 days, and excellent if the photocatalytic fine particles did not aggregate or precipitate in 1 month. Whether or not the photocatalytic fine particles aggregated and precipitated was determined by visually checking the bottom of a transparent container for any deposits.

The dispersion of all the photocatalytic coating materials of Examples 1 to 7 and Comparative Examples 1 to 6 was evaluated in this manner.

### Evaluation of Initial Photocatalytic Capability

The photocatalytic coating material (2 grams) was dispensed dropwise uniformly across a piece of cellulose fabric (125 mm by 125 mm) by using a dropper. The cellulose fabric was dried using a drier that blew out air of 40° C. and then preliminarily irradiated with light from a blue LED (4,500 lux) for 48 hours, to prepare a test sample. Next, the test sample was placed inside a 1-liter gas bag, and 100 ppm gaseous acetaldehyde was injected into this gas bag. The test sample inside the gas bag was irradiated with light from a blue LED (4,500 lux) for 5 hours, after which the concentration of the gaseous acetaldehyde in the gas bag was measured using a detector tube.

The residual ratio of the gas was calculated using the following formula, to evaluate the initial photocatalytic capability of the photocatalytic coating material.

Gas Residual Ratio=(Gas Concentration after 5 Hours of Irradiation)/(Initial Gas Concentration (=100 ppm))

The photocatalytic coating material was evaluated as being excellent if the gas residual ratio was 5% or less, good if the gas residual ratio was from 5% inclusive to 20% exclusive, fair if the gas residual ratio was from 20% inclusive to 50% exclusive, and poor if the gas residual ratio was 50% or higher.

The initial photocatalytic capability of all the photocatalytic coating materials of Examples 1 to 7 and Comparative Examples 1 to 6 was evaluated in this manner.

### Evaluation of Long Term Antiseptic Effect

First, a bacterial solution was prepared by the following procedures. First of all, an agar medium was left outdoors for approximately 3 days. The entire agar medium was then stored at a temperature of 25° C. and a humidity of 70% for 7 days to culture bacteria. The entire bacteria-cultured agar medium was placed in 1 liter of pure water. The mixture was thoroughly stirred with a medicine spoon in such a manner that the agar medium in the water could be crushed. Thereafter, the water containing the crushed agar medium was filtered through a mesh with 20-μm openings, to obtain a filtrate (i.e., a bacterial solution).

Next, a photocatalytic coating material (9.8 mL) and the bacterial solution (0.2 mL) were put in a screw-capped tube and mixed to obtain a liquid mixture that was then left to sit at a temperature of 25° C. and a humidity of 70% for 7 days.

The resultant liquid mixture was dispensed dropwise at 4 points on the agar medium (20 μL for each point). The agar medium was then cultured at a temperature of 25° C. and a humidity of 70% for 3 days.

The photocatalytic coating material was evaluated as being excellent if no colony generation was recognized on the cultured agar medium, good if colony generation was recognized at 1 to 2 points out of the 4 points where the liquid mixture was dispensed dropwise, and poor if colony generation was recognized at 3 or more points out of the 4 points where the liquid mixture was dispensed dropwise.

The long-term antiseptic effect of all the photocatalytic coating materials of Examples 1 to 7 and Comparative Examples 1 to 6 was evaluated in this manner.

Tables 3 and 4 collectively show evaluation results.

TABLE 3

| | Dispersion | Initial Photocatalytic Capability | Long-term Antiseptic Effect |
|---|---|---|---|
| Example 1 | Good | Excellent | Good |
| Example 2 | Good | Excellent | Excellent |
| Example 3 | Good | Excellent | Excellent |
| Example 4 | Good | Excellent | Excellent |
| Example 5 | Good | Good | Good |
| Example 6 | Excellent | Good | Good |
| Example 7 | Excellent | Good | Good |

TABLE 4

| | Dispersion | Initial Photocatalytic Capability | Long-term Antiseptic Effect |
|---|---|---|---|
| Comp. Ex. 1 | Good | Good | Poor |
| Comp. Ex. 2 | Good | Good | Poor |
| Comp. Ex. 3 | Good | Good | Poor |
| Comp. Ex. 4 | Good | Poor | Good |
| Comp. Ex. 5 | Good | Good | Poor |
| Comp. Ex. 6 | Good | Poor | Good |

Comp. Ex. = Comparative Example

The photocatalytic coating materials of Examples 1 to 7 were evaluated as being either good or excellent across all the properties considered: namely, dispersion, initial photocatalytic capability, and long-term antiseptic effect. The photocatalytic coating materials of Comparative Examples 1 to 3 and 5 were evaluated as being poor in terms of long-term antiseptic effect. The photocatalytic coating materials of Comparative Examples 1 and 2 exhibited a poor long-term antiseptic effect presumably due to the low silver ion content thereof. The photocatalytic coating materials of Comparative Examples 3 and 5 exhibited a poor long-term antiseptic effect presumably due to the low methylparaben or sodium benzoate content thereof.

The photocatalytic coating materials of Comparative Examples 4 and 6 were evaluated as being poor in terms of initial photocatalytic capability. Methylparaben or sodium benzoate may possibly inhibit the photocatalytic activity of these photocatalytic coating materials.

What is claimed is:

1. A photocatalytic coating material comprising:
a dispersion medium containing water;
photocatalytic fine particles dispersed in the dispersion medium; and
silver ions, wherein
a concentration of the silver ions of the photocatalytic coating material is 0.6 ppm or more.

2. The photocatalytic coating material according to claim 1, further comprising zinc ions.

3. The photocatalytic coating material according to claim 1, wherein the photocatalytic fine particles in the photocatalytic coating material have a volume average particle diameter D50 of 500 nm or less as measured by laser diffraction/scattering.

4. The photocatalytic coating material according to claim 1, wherein the photocatalytic fine particles contain tungsten oxide as a primary component.

5. The photocatalytic coating material according to claim 1, further comprising: an inorganic porous material, wherein the silver ions are either carried by the inorganic porous material or eluted from the inorganic porous material into the dispersion medium.

6. The photocatalytic coating material according to claim 1, further comprising a dispersant.

7. A sprayer product comprising:
the photocatalytic coating material according to claim 1; and
a sprayer that sprays the photocatalytic coating material.
